(19) United States
(12) Patent Application Publication
(10) Pub. No.: US 2012/0077364 A1
(43) Pub. Date: Mar. 29, 2012

(54) ELECTRICAL CONNECTOR WITH ENGAGEMENT MECHANISM

(75) Inventors: John W. Boyer, Portland, OR (US); John O. George, III, North Plains, OR (US); Roger A. Mach, Beaverton, OR (US)

(73) Assignee: International Business Machines Corporation, Armonk, NY (US)

(21) Appl. No.: 12/893,214

(22) Filed: Sep. 29, 2010

(51) Int. Cl. H01R 13/62

(52) U.S. Cl. 439/345

(57) ABSTRACT

A connector configured with a mechanism for rapid engagement with another electrical connector is provided. In one general embodiment, the electrical connector comprises a connector body, first and second engagement posts, and an engagement mechanism coupled to the engagement posts. Actuation of the engagement mechanism simultaneously actuates the first and second engagement posts.

### BACKGROUND

1. Field of the Invention

The present invention relates generally to electrical connectors, and more particularly, to an electrical connector having a mechanism for rapid engagement with another electrical connector.

2. Background Information

An electrical connector may include captive threaded fasteners for mechanically joining to another connector. Two electrical connectors may be joined by aligning threaded fasteners on one of the connectors with complementary threaded fasteners on the other connector, then rotating threaded fasteners on one of the connectors, until the two connectors are held together and make good electrical contact with each other. It may be necessary to rotate the threaded fasteners through many revolutions to fully engage or disengage two electrical connectors. The threaded fasteners provide a means for drawing two electrical connectors together and for preventing a joined pair of electrical connectors from being separated by vibration, thermal expansion and contraction, or by external forces pulling on electrical conductors attached to the connectors.

Threaded fasteners included with electrical connectors often have a knurled or faceted surface near one end of the fastener to enable the fastener to be rotated by hand without the use of tools. A threaded fastener may also have an end configured with a slot for receiving a screwdriver, or flat portions for gripping the fastener with a wrench or nut driver, or other features to facilitate gripping and rotating the fastener with a tool.

However, a person who desires to connect or disconnect two electrical connectors may not have the appropriate tool at hand. Additionally, cables and connectors may be crowded close together, making it difficult to rotate the threaded fasteners either with tools or by hand. Further, there may be insufficient lighting near a connector to see if a tool is properly engaged with a threaded fastener for rotating the fastener.

For known electrical connectors, threaded fasteners are rotationally independent of each other, requiring each fastener to be gripped and turned individually. Since it may be necessary to rotate the threaded fasteners through many revolutions to fully engage or disengage the electrical connectors, the connectors are often simply pushed together or pulled apart by hand to connect and disconnect the electrical connectors. Failing to use the threaded fasteners may lead to unreliable electrical connections. Even when the threaded fasteners are used, care must be taken to avoid mechanically stressing an electrical connector by rotating one threaded fastener through many turns before rotating another threaded fastener on the same connector. Uneven rotation of the threaded fasteners may cause bending stresses on the connector large enough to crack the connector's body or deform electrical contacts in the connector. Careless use of a tool to rotate the threaded fasteners may cause damage to the connector and may lead to repair or replacement of the entire connector.

### BRIEF SUMMARY

In one general embodiment, an electrical connector comprising a connector body, first and second engagement posts, and an engagement mechanism coupled to the engagement posts. Actuation of the engagement mechanism simultaneously actuates the first and second engagement posts.

In another embodiment, an electrical connector that comprises a connector body and an engagement post attached to the connector body. The engagement post includes a hollow tube, a pin that slides within the hollow tube, and a ring of flexible polymer material attached to an end of the hollow tube. The ring has a relaxed outer diameter and an expanded outer diameter. The engagement post is adapted to firmly grip a screw lock on another connector when the pin causes the ring to increase from the relaxed outer diameter to the expanded outer diameter.

In another embodiment, an electrical connector that comprises a first engagement post with a threaded end and a second engagement post with a threaded end. The second engagement post is rotationally coupled to the first engagement post. The connector further includes a contact block for holding a plurality of electrical contacts and a connector body for holding the first and second engagement posts and the contact block. Rotation of the first engagement post causes the second engagement post to rotate simultaneously with the first engagement post. Rotation of the first and second engagement posts is adapted to connect the contact block to a corresponding contact block in another electrical connector.

### BRIEF DESCRIPTION OF THE SEVERAL VIEWS OF THE DRAWINGS

FIG. 1 is a cut-away plan view of an exemplary embodiment of a connector body of an electrical connector;

FIG. 2 is a cut-away plan view of another embodiment of a connector body of an electrical connector;

FIG. 3 is a cut-away plan view a further embodiment of a connector body of an electrical connector;

FIG. 4 is an end view of an embodiment of the electrical connector of FIG. 2, illustrating an exemplary gear train;

FIG. 5 illustrates an end view of an embodiment of an electrical connector of FIG. 3, illustrating an exemplary drive belt for rotationally coupling two engagement posts;

FIG. 6 illustrates an end view of an embodiment of a engagement post;

FIG. 7 illustrates a cross sectional view of the engagement post of FIG. 6 taken along lines A-A of FIG. 6;

FIG. 8 illustrates an end view of another embodiment of an engagement post;

FIG. 9 illustrates a cross sectional view of the engagement post of FIG. 8 taken along lines B-B of FIG. 8;

FIG. 10 illustrates an end view of a further exemplary embodiment of an engagement post;

FIG. 11 illustrates a cross sectional view of the engagement post of FIG. 10 taken along lines C-C of FIG. 10;

FIG. 12 illustrates an end view of the engagement post of FIGS. 10 and 11 with a compressed annular ring;

FIG. 13 illustrates a cross sectional view taken along lines D-D in FIG. 12;

FIG. 14 illustrates an embodiment of a connector body configured with engagement posts adapted for gripping an internally threaded fastener in another connector;

FIG. 15 illustrates an end view of an embodiment of an electrical connector configured with engagement posts rotationally coupled to one another by a roller chain; and

FIG. 16 illustrates an end view of an embodiment of an electrical connector configured with engagement posts rotationally coupled to one another by a ball chain.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The embodiments described below disclose electrical connector configured with a mechanism for rapid engagement with another electrical connector. In one general embodiment, an electrical connector comprising a connector body, first and second engagement posts, and an engagement mechanism coupled to the engagement posts. Actuation of the engagement mechanism simultaneously actuates the first and second engagement posts.

In another embodiment, an electrical connector that comprises a connector body and an engagement post attached to the connector body. The engagement post includes a hollow tube, a pin that slides within the hollow tube, and a ring of flexible polymer material attached to an end of the hollow tube. The ring has a relaxed outer diameter and an expanded outer diameter. The engagement post is adapted to firmly grip a screw lock on another connector when the pin causes the ring to increase from the relaxed outer diameter to the expanded outer diameter.

In another embodiment, an electrical connector that comprises a first engagement post with a threaded end and a second engagement post with a threaded end. The second engagement post is rotationally coupled to the first engagement post. The connector further includes a contact block for holding a plurality of electrical contacts and a connector body for holding the first and second engagement posts and the contact block. Rotation of the first engagement post causes the second engagement post to rotate simultaneously with the first engagement post. Rotation of the first and second engagement posts is adapted to connect the contact block to a corresponding contact block in another electrical connector.

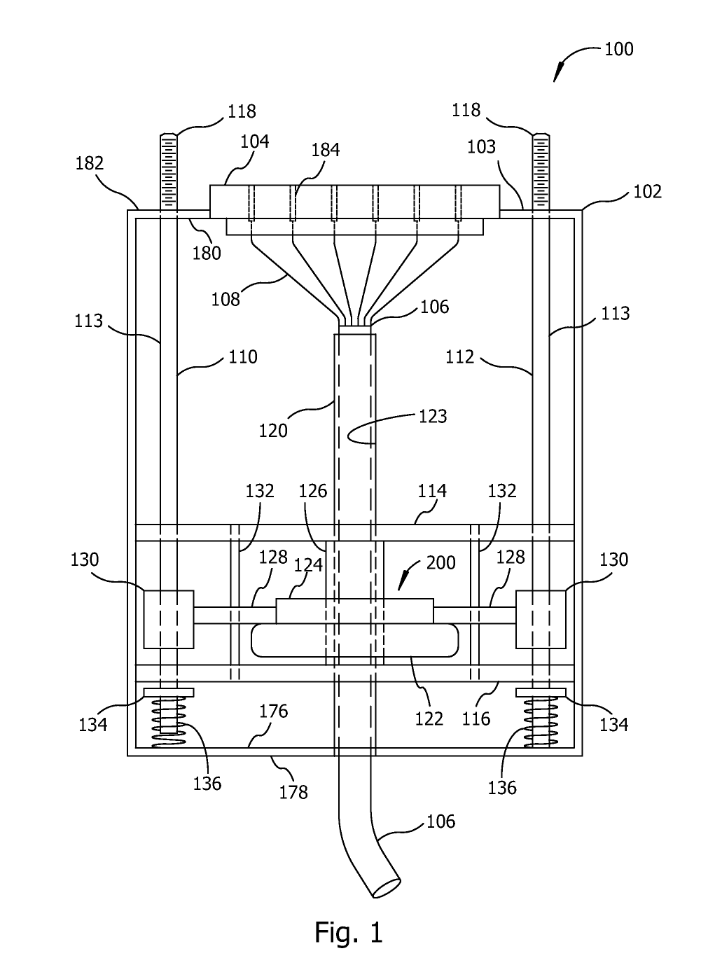

Referring now to FIG. 1 there is shown generally at 100, an electrical connector, according to one general embodiment. In the embodiment shown, the electrical connector 100 comprises a connector body 102 that includes a contact block 104 attached to a first side 103 of the connector body 102. The contact block 104 includes a plurality of electrical contacts 184 for making electrical connections to another electrical connector (not shown). In some embodiments, the contact block 104 may be made integral with the connector body 102. The contact block 104 may have a different shape than the shape shown in FIG. 1 and in subsequent Figures. The contact block 104 may be cylindrical, square, or any other shape suitable for coupling to another like-shaped contact block of another electrical connector (not shown) for coupling the two connectors. In some embodiments, the electrical contacts 184 may be removable from the contact block 104.

An electrical cable 106 comprising a plurality of electrical conductors 108 is coupled to the contact block 104 and optionally may be secured to the connector body 102. A first engagement post 110 and a second engagement post 112 are coupled to the connector body 102 by a gear plate 114. An optional second gear plate 116 may be provided for stabilizing the posts 110, 112 in the body 102. A post collar 134 is attached to each engagement post 110, 112 to prevent the posts 110, 112 from being inadvertently removed from the connector body 102. The collars 134 also provide a surface that compression springs 136 may act against. The compression springs 136 bias the engagement posts 110, 112 in a direction outward and away from the exterior front surface 182 of the connector body 102 and assist in coupling with a corresponding post in another connector.

In one embodiment, the engagement posts 110, 112 have an unthreaded portion 113 that is less than or equal to a length of the connector body 102. For clarity of understanding only, as shown in FIG. 1, the unthreaded portion 113 of the first engagement post 110 is less than the length of the connector body 102. Alternatively, the unthreaded portion 113 of the second engagement post 112 is about the same length of the connector body 102.

In one embodiment, each engagement post 110, 112 is configured with a threaded end 118 for coupling with a complementary threaded fastener in another connector. In an alternative embodiment, the threaded ends 118 may be formed with a hollow cylindrical end and internal threads (not shown).

Referring still to FIG. 1, in one embodiment, the first and second engagement posts 110, 112 are rotationally coupled together so that both posts 110, 112 may be rotated simultaneously in a same direction of rotation and at a same rate of rotation for coupling two connectors. Rotationally coupling the engagement posts 110, 112 together so that they simultaneously rotate in a same direction rotation and at a same rate of rotation may substantially reduce mechanical stresses on electrical connectors and reduce an amount of time needed to connect or disconnect electrical connectors.

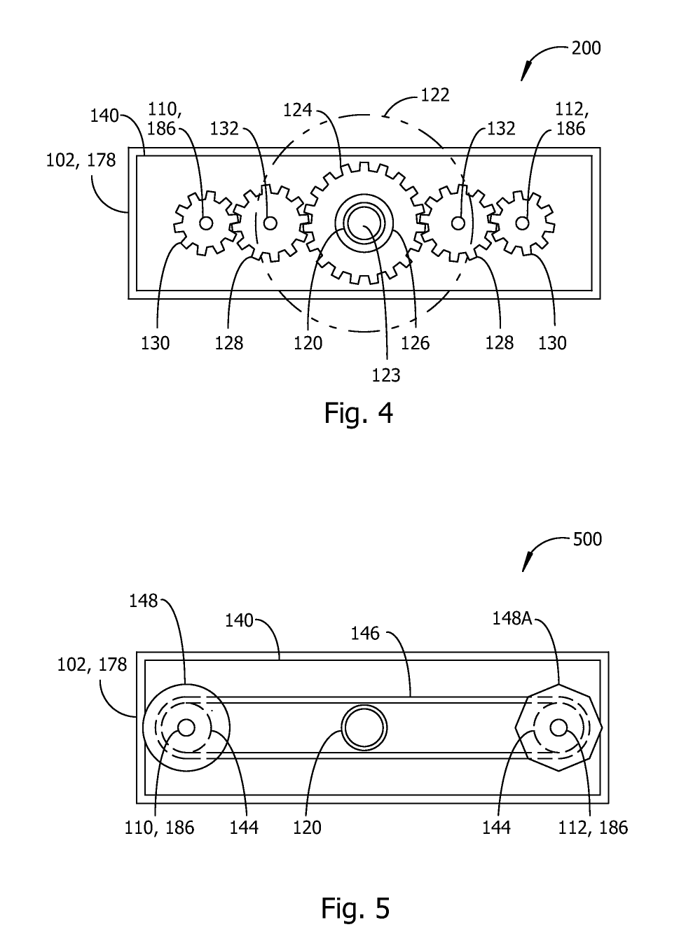

Referring to FIG. 1 and FIG. 4, in one embodiment a gear train, shown generally at 200, is provided for rotationally coupling the first engagement post 110 and the second engagement post 112. In the embodiment shown, the gear train 200 comprises a pair of outer gears 130, each of which is coaxially coupled to an engagement post 110, 112, and a pair of intermediate gears 128 that are rotatably coupled to the outer gears 130 and to a central gear 124. The gear train 200 further comprises a thumbwheel 122 that is attached to a thumbwheel hub 126. In the embodiment shown, the thumbwheel 122 may be rotated by hand to rotate the central gear 124 and drive the gear train 200 in rotation, thus causing both engagement posts 110, 112 to rotate in a same direction of rotation and at a same rate of rotation. In one embodiment, the thumbwheel 122 may be faceted or knurled (shown in FIG. 5).

In one embodiment, the thumbwheel hub 126 rotates coaxially about a stationary hollow shaft 120 that is affixed to the first gear plate 114 and to the second gear plate 116, when the body 102 is configured with the second gear plate 116. The hollow shaft 120 may be formed with a central axial aperture 123 having a diameter selected to be large enough to admit the electrical cable 106. Each of the intermediate gears 128 rotate about a separate axle pin 132 attached to the first gear plate 114 and to the second gear plate 116, when provided.

Referring again to FIG. 1, in one embodiment, a spring 136 may be coaxially positioned on one or both engagement posts 110, 112. For example, a first helical compression spring 136 is coaxially located on the first engagement post 110 between the post collar 134 and an interior back surface 176 of the connector body 102. Additionally, a second helical compression spring 136 may be coaxially located on the second engagement post 112.

As shown in FIG. 1 and FIG. 4, the gear train 200 is located inside the connector body 102. Such an arrangement is well suited for assembly into a new electrical connector 100 during its manufacture. However, other engagement mechanism embodiments may be advantageous for retrofit to an existing connector originally provided with rotationally independent captive threaded fasteners, for example.

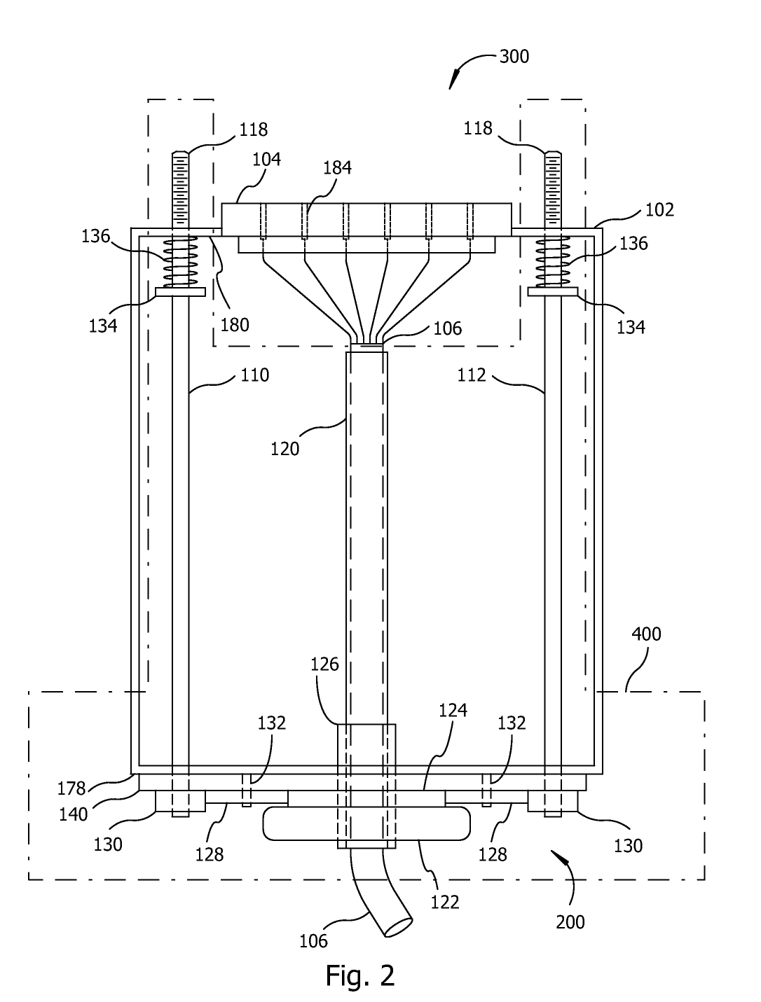

With reference to FIG. 2, there is shown an embodiment of an electrical connector 300 having an external engagement mechanism 400 positioned external to the connector body 102. In one embodiment, the external engagement mechanism 400 comprises an external gear train 200, that is substantially similar to the gear train 200 of FIG. 4, and is coupled to an exterior back surface 178 of the connector body 102. The first engagement post 110 and second engagement post 112 are provided to replace threaded fasteners that were originally provided with the electrical connector. The gear train 200 again comprises the pair of outer gears 130, intermediate gears 128, a central gear 124, and the thumbwheel 122. The thumbwheel 122 is attached to the thumbwheel hub 126 that rotates about a hollow shaft 120. The gear train 200 functions as previously described.

Each of the engagement posts 110, 112 includes a post collar 134. In one embodiment, a helical tension spring 136 may be positioned coaxially on an engagement post near an interior front surface 180 of the connector body 102, with one end of the helical tension spring pressing against the interior front surface 180 and another end of the spring pressing against the post collar 134. The tension springs 136 bias the engagement posts 110, 112 in a direction outward and away from the exterior front surface 182 of the connector body 102 and assist in coupling with a corresponding post in another connector.

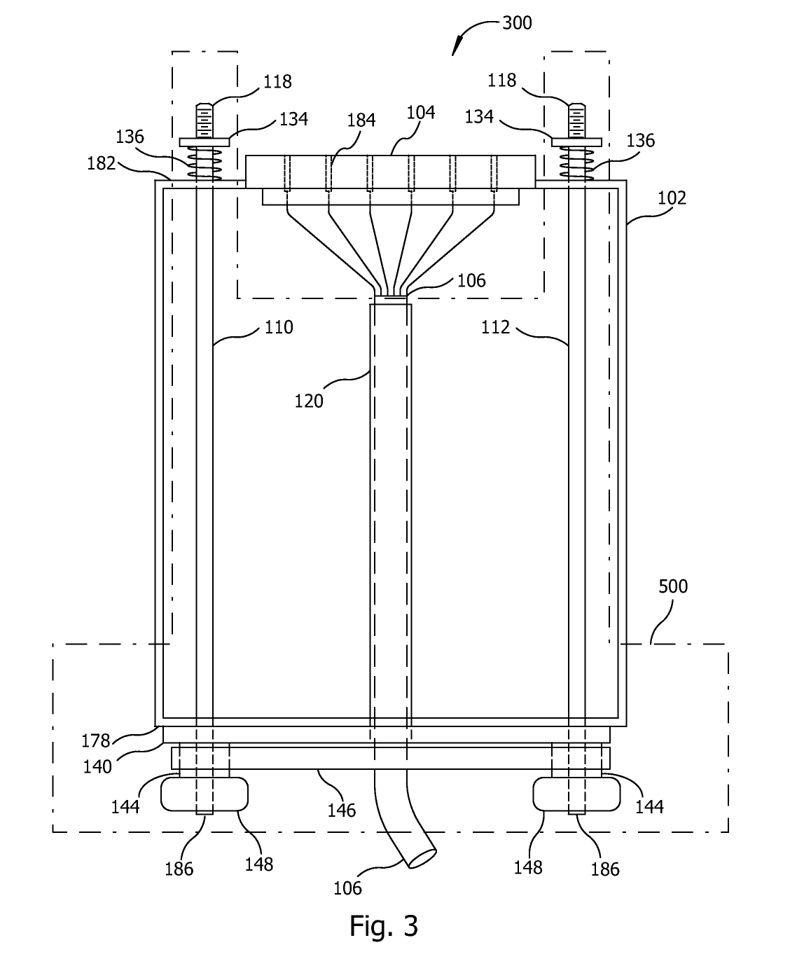

Referring to FIG. 3 and FIG. 5, an alternative embodiment of an external engagement mechanism 500 is shown. In the embodiment shown, the first and second engagement posts 110, 112 are rotationally coupled by a flexible belt 146. A pulley 144 is affixed to the first engagement post 110 near an end 186 thereof and similarly, another pulley 144 affixed to the second engagement post 112 near an end 186 thereof. The belt 146 is coupled to the pulleys 144 for rotationally coupling the posts 110, 112 together, so that both may be rotated simultaneously in a same direction of rotation and at a same rate of rotation. Rotating a thumbwheel 148 attached to the end 186 of the first engagement post 110 rotates both pulleys 148, and thus, rotates the engagement posts 110, 112 in a same direction. In one embodiment, a second thumbwheel 148 may be attached to the end 186 of the second engagement post 112. In one embodiment, the engagement posts 110, 112 and pulleys 144 are supported by a gear plate 140 attached to an exterior back surface 178 of the connector body 102. Each of the engagement posts 110, 112 may include a post collar 134 near the threaded end 118 of the post.

In one embodiment, a helical compression spring 136 may be placed coaxially over each engagement post 110, 112 between the post collar 134 and an exterior front surface 182 of the connector body 102. Several alternative connector embodiments may be made by substituting a spring type (compression or tension), spring position, and position of the post collar 134 from any one of the embodiments illustrated in the Figures.

Referring particularly to FIG. 4, an embodiment of the gear train 200 is shown. The central gear 124 is attached to the thumbwheel hub 126. The thumbwheel hub 126 rotates about the stationary hollow shaft 120 that is connected to the gear plate 140. The thumbwheel 122 (represented with a phantom line to better illustrate other components of the gear train 200) is also attached to the thumbwheel hub 126. The two intermediate gears 128 are rotationally coupled to the gear plate 140 by axle pins 132 and are driven in rotation by the central gear 124 and thumbwheel 122. The intermediate gears 132 drive the outer gears 130 on the engagement posts 110, 112, for rotating the posts 110, 112 in a same direction of rotation. In one embodiment, gear ratios may be selected to cause an outer gear 130 and its associated engagement post 110, 112 to rotate more than once for each complete rotation of the thumbwheel 122.

Referring particularly to FIGS. 5, 15, and 16, various embodiments of the external engagement mechanism 500 are shown. The external engagement mechanism 500 shown in FIG. 5, includes the hollow shaft 120 that attached to the gear plate 140 on an exterior back surface 178 of the connector body 102. The first pulley 144 is attached near the end 186 of the first engagement post 110 and the second pulley 144 is attached near the end 186 of the other engagement post 112. In a preferred embodiment, a flexible belt 146 is connected between the two pulleys 144 so that both pulleys and their associated engagement posts 110, 112 rotate in a same direction of rotation when the thumbwheel 148 is rotated. In one embodiment, a second thumbwheel 148A may be attached to the second engagement post 112. The second thumbwheel 148A may have a diameter and thickness selected for a convenient finger grip and may be formed with faceted or knurled sides, for example, to make the thumbwheel 148A easier to grip and turn by hand.

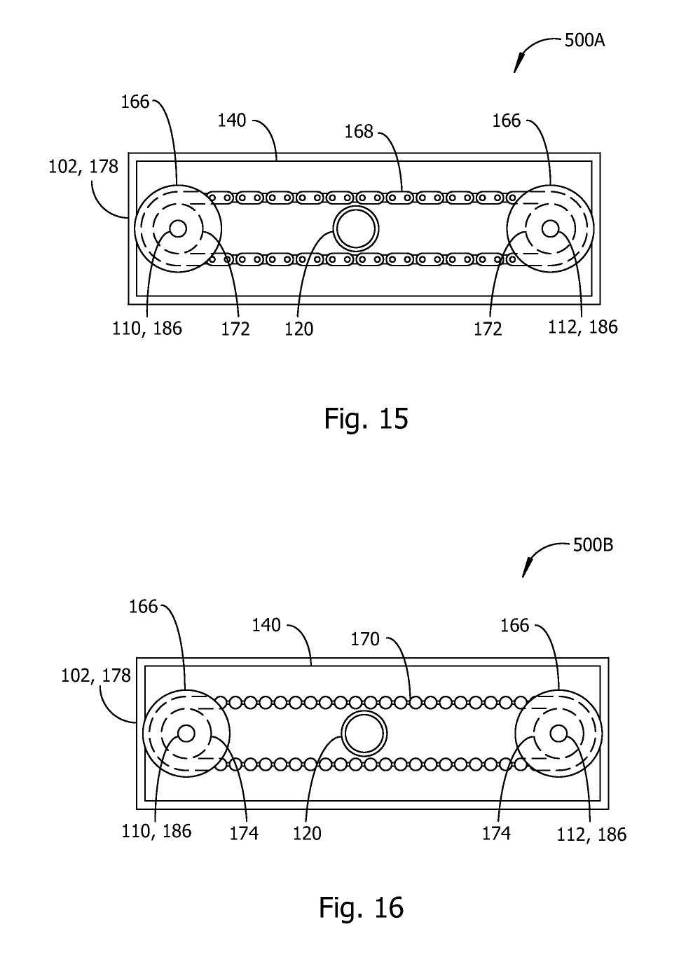

An alternative embodiment of the external engagement mechanism 500 of FIG. 5 is shown in FIG. 15. In this alternative embodiment of the external engagement mechanism 500A, the flexible drive belt is replaced with a roller chain 168. A thumbwheel 166 and a roller chain sprocket 172 adapted for engaging the roller chain 168 is attached to each of the engagement posts 110, 112 near an end 186 of each post.

Another alternative embodiment of external engagement mechanism 500B is shown in FIG. 16. In this embodiment, a ball chain 170 is provided for rotationally coupling the engagement posts 110, 112. The ball chain 170 engages ball chain sprockets 174 that are attached to each engagement post 110, 112. Any of the alternative embodiments of the external engagement mechanism 500 may optionally be provided as components for retrofit to an electrical connector originally supplied with rotationally independent captive threaded fasteners.

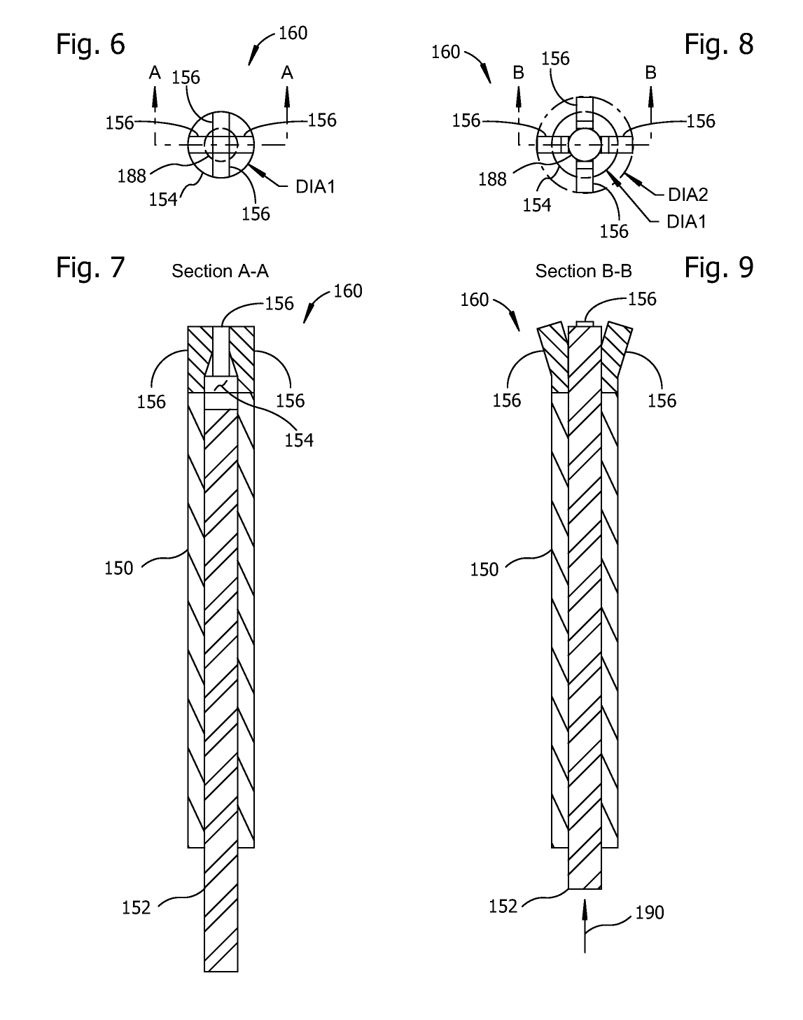

Referring to FIGS. 6-13, an embodiment of an electrical connector 100 (e.g. shown in FIG. 1) may include engagement posts configured with means for gripping an internally threaded fastener in another connector without requiring the engagement posts to be rotated, as discussed previously. It is considered that embodiments of an engagement post may be provided with a thread gripping feature configured with a hollow tube with an annular ring of flexible polymer material attached to one end of the tube. The hollow tube may extend from a connector body on a side with an electrical connector and has an outer diameter selected for a sliding fit into an internally threaded fastener on another connector. A pin can be inserted into the hollow tube at an end opposite the ring of flexible polymer material. When the pin is pushed into the tube, or in some embodiments partially pulled from the tube, the pin presses against the ring of polymer material and an outer diameter of the ring changes from a relaxed outer diameter to an expanded outer diameter. The relaxed outer diameter of the ring of flexible polymer material is selected for a clearance fit in an internally threaded fastener on another connector. The expanded outer diameter of the ring is selected to be large enough to firmly grip the threads in the internally threaded fastener. The ring of flexible polymer material changes from an expanded outer diameter back to a relaxed outer diameter when the pin is moved away from contact with the ring.

Referring particularly to FIGS. 6-9, an embodiment of a engagement post 160 is configured with four flexible vanes 156 that are attached on a same side of an annular ring 154 made from a flexible polymer material. In FIG. 6 and Section A-A in FIG. 7, the flexible vanes 156 are shown in a relaxed position having a relaxed outer diameter DIA1. The engagement post 160 includes a pin 152 adapted for a sliding fit within a central axial aperture 188 of a hollow tube 150.

FIG. 8 and Section B-B in FIG. 9 show the flexible vanes 156 in an expanded position. The pin 152 is pushed into the hollow tube 150 in the direction shown by an arrow 190 until the flexible vanes 156 are pushed apart into the expanded position. In the expanded position, the flexible vanes 156 have an expanded outer diameter DIA2, that is greater than outer diameter DIA1 and is sufficiently large for gripping threads in another connector (not shown). The engagement post 160 is configured for insertion into or withdrawal from an internally threaded fastener in another connector.

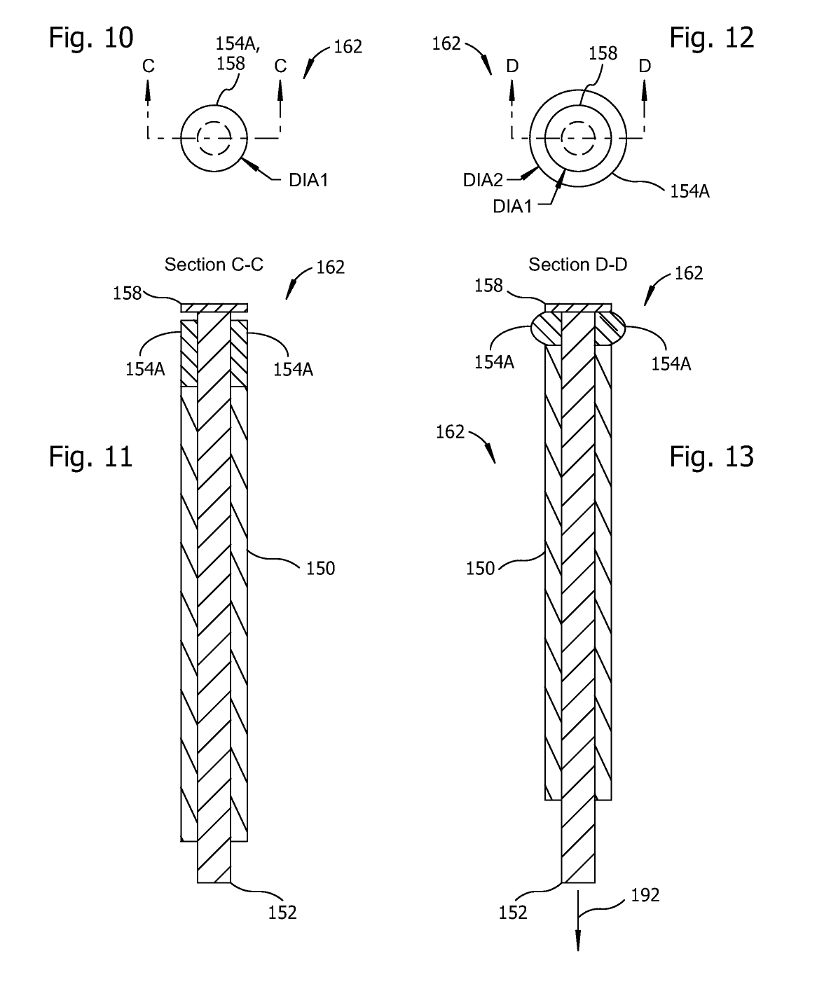

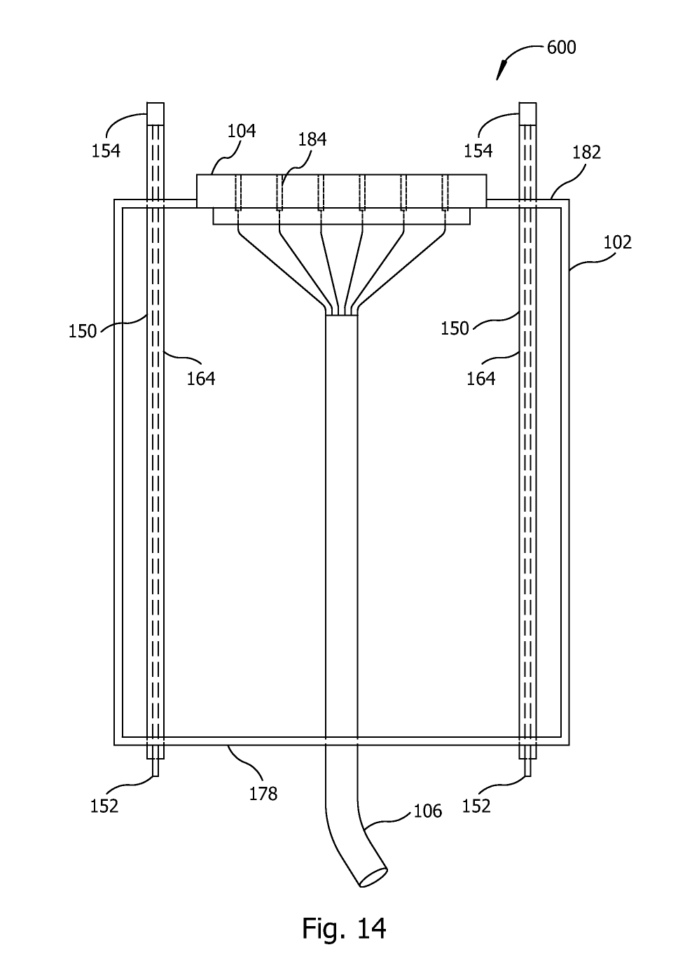

Referring particularly to FIGS. 10-13, an alternative embodiment of an engagement post 162 is shown. The alternative embodiment of the engagement post 162 includes an axially compressible ring 154A of flexible polymer material attached to an end of the hollow tube 150. Additionally, a pin collar 158 is attached to an end of the pin 152. The pin collar 158, pin 152, hollow tube 150, and ring 154A are shown in relation to one another in Section C-C in FIG. 11. The ring 154A is shown with a relaxed outer diameter in FIG. 11, corresponding to the diameter DIA1 in FIG. 10. FIG. 12 is an end view of the engagement post of FIGS. 10-11, showing the ring 154A expanded to outer diameter DIA2. FIG. 13 is a cross sectional view D-D of the engagement post of FIGS. 10-12, showing the pin 152 partially pulled from the hollow tube 150 in the direction indicated by an arrow 192 until the pin collar 150 compresses the ring 154A and expands an outer diameter of the ring from a relaxed outer diameter DIA1 to an expanded outer diameter DIA2. FIG. 14 shows a side view of an embodiment of an electrical connector 600 comprising an engagement post 164 attached to a connector body 102. The engagement posts 164 in FIG. 14 are representative of either a post 160 as shown in FIGS. 6-9 or a post 162 as shown in FIGS. 10-13.

A pin will preferably be locked in position while it is being used to expand an outer diameter of a ring of flexible polymer material, and released from its locked position so that two connectors may be engaged or disengaged. Many different means are known for selectively locking and unlocking a pin in a hollow tube. For example, the pin and tube may be arranged for locking with a quarter turn in a selected direction and unlocking with a quarter turn in the opposite direction.

Those skilled in the art will appreciate that various adaptations and modifications can be configured without departing from the scope and spirit of the embodiments described herein. Therefore, it is to be understood that, within the scope of the appended claims, the embodiments of the invention may be practiced other than as specifically described herein.

What is claimed is:

1. An electrical connector comprising:
a connector body;
first and second engagement posts; and
an engagement mechanism coupled to the engagement posts, wherein actuation of the engagement mechanism simultaneously actuates the first and second engagement posts.

2. The electrical connector of claim 1, further comprising:
the first and second engagement posts rotatably coupled to the connector body; and
the engagement mechanism including a thumbwheel, wherein rotation of the thumbwheel causes the first and second engagement posts to rotate simultaneously in a same direction of rotation.

3. The electrical connector of claim 2, wherein the engagement mechanism further comprises:
a pair of pulleys, one pulley attached to each engagement post; and
a drive belt coupled to the pulleys and to the thumbwheel, wherein rotation of the thumbwheel causes the first and second engagement posts to rotate simultaneously in a same direction of rotation.

4. The electrical connector of claim 2, wherein the engagement mechanism further comprises:
first and second chain sprockets, with a chain sprocket attached to each engagement post; and
a chain coupled to the first and second chain sprockets and to the thumbwheel, wherein rotation of the thumbwheel causes the first and second engagement posts to rotate simultaneously in a same direction of rotation.

5. The electrical connector of claim 2, further comprising:
a gear train, the gear train comprising:
a hollow shaft for receiving an electrical cable;
first and second outer gears, each outer gear attached to an engagement post;
first and second intermediate gears coupled to the outer gears; and
a central gear adapted for rotation about the hollow shaft and coupled to the intermediate gears and to the thumbwheel, wherein rotation of the thumbwheel causes the first and second engagement posts to rotate simultaneously in a same direction of rotation.

6. The electrical connector of claim 5, wherein the hollow shaft has an inner diameter selected for a clearance fit of a selected electrical cable.

7. The electrical connector of claim 5, wherein the first and second engagement posts complete more than one rotation for each complete rotation of the thumbwheel.

8. The electrical connector of claim 2, further comprising:
the first and second engagement posts further comprising a post collar; and
helical compression springs, each compression spring coaxially positioned with each engagement post and interposed between the post collar and the connector body, the springs biasing an end of each engagement post outwardly from the connector body.

9. The electrical connector of claim 8, further comprising:
wherein each of the first and second engagement posts further comprises:
a threaded end;
a post collar inside the connector body near the threaded end; and
a helical tension spring coaxially positioned on the engagement post and interposed between the post collar and the connector body, the spring biasing the threaded end of the engagement post outwardly from the connector body.

10. The electrical connector of claim 8, further comprising:
wherein each of the first and second engagement posts further comprises:
a threaded end;
a post collar outside the connector body near the threaded end; and
a helical tension spring coaxially positioned on the engagement post and interposed between the post collar and the connector body, the spring biasing the threaded end of the engagement post outwardly from the connector body.

11. The electrical connector of claim 8, wherein the first outer gear, second outer gear, first intermediate gear, and second intermediate gear are located within the connector body.

12. The electrical connector of claim 2, further comprising a gear plate coupled to an outer surface of the connector body, the gear plate supporting the engagement mechanism when the engagement mechanism is positioned outside of the connector body.

13. An electrical connector comprising:
a connector body; and
an engagement mechanism coupled to the connector body, the engagement mechanism comprising a post that comprises:
a hollow tube extending a length of the post;
a pin slidably disposed within the hollow tube; and
a flexible ring attached to an end of the hollow tube,
wherein the ring has a relaxed outer diameter and an expanded outer diameter and the engagement post is adapted to firmly grip a lock on another connector when the pin causes the ring to increase from the relaxed outer diameter to the expanded outer diameter.

14. The electrical connector of claim 13 further comprising:
a pin collar attached to an end of the pin, wherein pulling an end of the pin opposite the pin collar causes an outer diameter of the ring to increase from the relaxed outer diameter to the expanded outer diameter.

15. The electrical connector of claim 14 further comprising:
a pin collar attached to the pin at a selected distance from an end of the pin, wherein pushing an end of the pin causes an outer diameter of the ring to increase from the relaxed outer diameter to the expanded outer diameter.

16. The electrical connector of claim 15, wherein the ring comprises at least two fins having an outer diameter and the outer diameter increases from the relaxed outer diameter to the expanded outer diameter when the pin presses against the fins.

17. The electrical connector of claim 14, further comprising a second post.

18. The electrical connector of claim 13, wherein the engagement post is adapted to firmly grip a screw lock on another connector when the outer diameter of the ring is expanded.

19. The electrical connector of claim 13, wherein the ring comprises a flexible polymer material.

20. An electrical connector comprising:
a first engagement post having a threaded end;
a second engagement post having a threaded end, wherein the second engagement post is rotatably coupled to the first engagement post;
a contact block for holding a plurality of electrical contacts; and
a connector body for holding the first engagement post, the second engagement post, and the contact block,
wherein rotation of the first engagement post causes the second engagement post to rotate simultaneously with the first engagement post and rotation of the first and second engagement posts is adapted to connect the contact block to a corresponding contact block in another electrical connector.
